(19) United States
(12) Patent Application Publication
(10) Pub. No.: US 2011/0072456 A1
(43) Pub. Date: Mar. 24, 2011

(54) System and Method for Substituting Broadband Delivered Advertisements for Expired Advertisements

(75) Inventors: Scott White, Austin, TX (US); James L. Cansler, Cedar Park, TX (US); Ian C. Schmehl, Buda, TX (US)

(73) Assignee: AT&T INTELLECTUAL PROPERTY I, L.P., Reno, NV (US)

(21) Appl. No.: 12/566,285

(22) Filed: Sep. 24, 2009

(51) Int. Cl. H04N 7/025; H04N 5/91

(52) U.S. Cl. 725/32; 725/109; 386/E05.003

(57) ABSTRACT

An Internet Protocol television (IPTV) system includes an advertising module adapted to read metadata information associated with an advertising item included within a content item recorded on a set-top box, determine that the advertising item is expired, and send another advertising item to the set-top box to be played on the set-top box in the place of the first advertising item when the content item is played on the set-top box. A method includes determining that an advertising item that is included within a content item that is recorded on a set-top box is expired, deleting the advertising item from the set-top box, recording a second advertising item on the set-top box, and playing the second advertising item in the place of the first advertising item when the content item is played on the set-top box.

### FIELD OF THE DISCLOSURE

The present disclosure generally relates to an Internet protocol television system, and more particularly relates advertising content on an Internet protocol television system.

### BACKGROUND

An Internet protocol television (IPTV) service provider can transmit an IPTV signal to a user of the IPTV system via a central office, a serving area interface, and a residential gateway. The IPTV service provider can offer the user a variety of different content and services. For example, the IPTV service provider can supply users with real-time television programs that are typically available for the users to watch only at a specific date and time. The IPTV service providers can also offer the users on-demand movies that are available for an extended amount of time and that are provided to the users upon request of the on-demand movie. The user can also record audio or video content for storage in a digital format on the user's set-top box or on a data server on the IPTV system.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of an IPTV network;

FIG. 2 is a block diagram of another embodiment of an IPTV network, including an advertising system;

FIG. 3 is an illustration of a content item, including advertising content, that is recorded on a set-top box;

FIG. 4 is a flowchart illustrating a method of using an advertising system; and

FIG. 5 is a block diagram showing an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed systems, methods or computer-readable media. Moreover, some statements may apply to some inventive features but not to others.

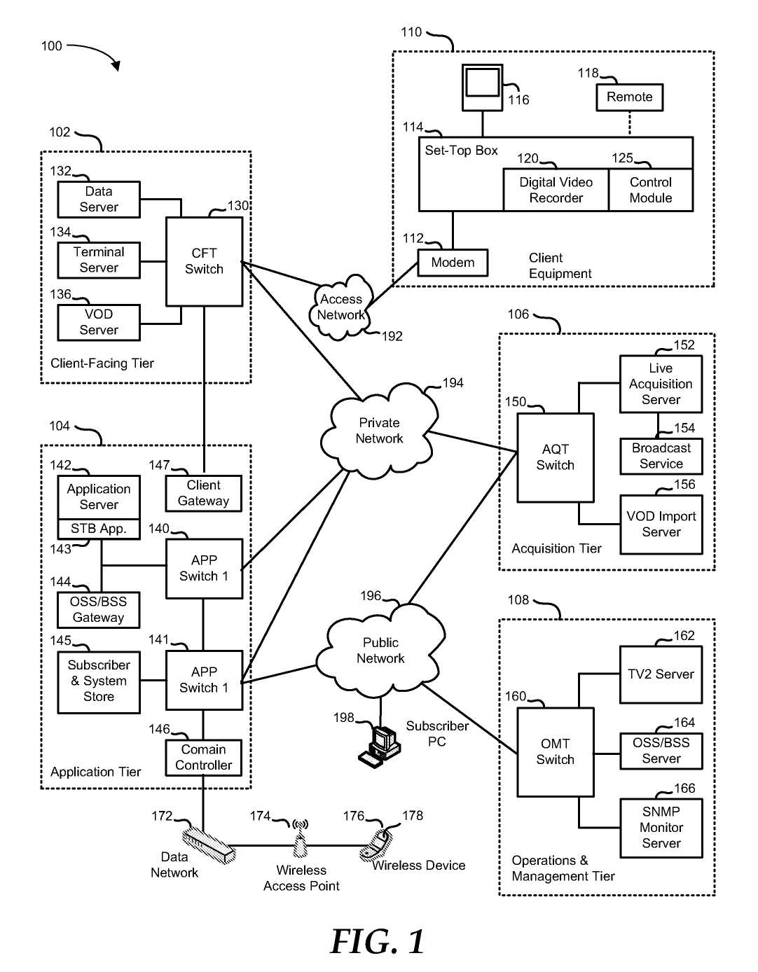

FIG. 1 shows an embodiment of an IPTV system 100 including a client facing (CF) tier 102, an application tier 104, an acquisition tier 106, an operations and management (OM) tier 108, and one or more sets of client equipment 110. Client equipment 110 is typically located at the home or business premises of a subscriber to the IPTV system 100. IPTV system 100 includes an access network 192, a private network 194, and a public network 196. Each tier 102, 104, 106, and 108 is coupled to one or more of access network 192, private network 194, and public network 196. In an embodiment, CF tier 102 is coupled to access network 192 and to private network 194, application tier 104 is coupled to private network 194 and to public network 196, acquisition tier 106 is coupled to private network 194 and to public network 196, and OM tier 108 is coupled to public network 196. Client equipment 110 is coupled to access network 192.

Networks 192, 194 and 196 communicate information between tiers 102, 104, 106, and 108, and client equipment 110. Access network 192 communicates information between CF tier 102 and client equipment 110. Private network 194 communicates information between CF tier 102 and application tier 104, between application tier 104 and acquisition tier 106, and between acquisition tier 106 and CF tier 102. Public network 196 communicates information between application tier 104 and acquisition tier 106, between acquisition tier 106 and OM tier 108, and between OM tier 108 and application tier 104. Information is also communicated directly between CF tier 102 and application tier 104, as described below. The information communicated between tiers 102, 104, 106, and 108, and client equipment 110 includes encoded television programs, audio files, data files, commands, procedures, other information, or any combination thereof.

CF tier 102 communicates with multiple sets of client equipment 110 over a wide geographic area, such as a regional area, a metropolitan area, a viewing area, or any other suitable geographic area that is supported by access network 192. Client equipment 110 includes a modem 112, a set-top box 114, a display device 116, and a remote control 118. The set-top box 114 includes a digital video recorder (DVR) 120 and a control module 125. Modem 112 is coupled to access network 192, and translates information from a form suitable for transmission over access network 192 to a form suitable for use by set-top box 114, and vice versa. In a non-limiting example, modem 112 is coupled to access network 192 via fiber-optic cables, a digital subscriber line (DSL), another network fabric, or any combination thereof.

The information that CF tier 102 communicates to modem 112 is sent to set-top box 114, which processes the information into a form suitable for display by display device 116 or for recording by DVR 120. Set-top box 114 receives digitally encoded content from CF tier 102 for display on display device 116, or for recording by DVR 120. Set-top box 114 can also receive data from CF tier 102, and render or display the data on display device 116. Further, set-top box 114 can send data to CF tier 102. Such data can include service requests, or commands from the subscriber, received by set-top box 112 via remote control 118. In this way, the subscriber can request services or information or respond to a request for information from IPTV system 100. Control module 125 includes instructions that are executable by set-top box 114 to control the data flow between the subscriber and IPTV system 100. Control module 125 can include an IPTV software platform such as Microsoft® TV IPTV Edition.

Control module 125 can facilitate data communication between set-top box 114 and IPTV system 100. For example, control module 125 can include a procedure whereby set-top box 114 receives a request to record content on DVR 120, or sends a status to IPTV system 100 that the content has been recorded. Likewise, control module 125 can include a procedure whereby the subscriber can interact with IPTV system 100 to receive and execute a viewing preference that the subscriber has created in IPTV system 100. Such preferences can be created via remote control 118, or through a subscriber account that is accessible through public network 196, such as through a subscriber's personal computer 198. A non-limiting example of remote control 118 includes a hand-held controller device, a game controller device, a keyboard/mouse device, another control device, or any combination thereof.

CF tier 102 includes a client-facing tier (CFT) switch 130, a data server 132, a terminal server 134, and a video-on-demand (VOD) server 136. CFT switch 130 manages communication with client equipment 110 through access network 192 and with application tier 104 and acquisition tier 106 through private network 194. CFT switch 130 is coupled to data server 132 that stores data transmitted in response to subscriber requests. CFT switch 130 is also coupled to terminal server 134 that provides terminal devices, such as a game application server, or other devices with a common connection point to private network 194. CFT switch 130 is also coupled to VOD server 136.

Application tier 104 includes application tier (APP) switches 140 and 141, an application server 142, an operation systems and support/billing systems and support (OSS/BSS) server 144, a subscriber and system store 145, a domain controller 146, and a client gateway 147. APP switches 140 and 141 manage communication with CF tier 102 and acquisition tier 106 through private network 194. APP switch 141 also manages communication with acquisition tier 106 and OM tier 108 through public network 196. APP switch 140 is coupled to APP switch 141. APP switch 140 is also coupled to application server 142 and to OSS/BSS gateway 144. Application server 142 provides applications to set-top box 114 through a set-top box application 143, so that set-top box 114 can provide functions such as recording and displaying content, messaging, and processing of IPTV data and VOD material. OSS/BSS gateway 144 includes operation systems and support (OSS) data, and billing systems and support (BSS) data.

APP switch 141 is coupled to domain controller 146 and to subscriber and system store 145. Domain controller 146 provides web access, for example, to subscribers via public network 196. Subscriber and system store 145 includes account information that is associated with subscribers who access IPTV system 100 via private network 194 or public network 196. Application tier 104 also communicates data directly to CF tier 102 through client gateway 147. In this embodiment, client gateway 147 is coupled directly to CFT switch 130.

Client gateway 147 provides subscriber access to private network 194 and tiers coupled thereto. In particular, set-top box 114 accesses IPTV system 100 via access network 192 using information received from client gateway 147. Access network 192 provides security for private network 194. Client equipment 110 accesses client gateway 147 via access network 192, and client gateway 147 allows client equipment 110 to access private network 194 once client equipment 110 is authenticated or verified. Similarly, client gateway 147 prevents unauthorized client equipment (not illustrated), such as hacker computers or stolen set-top box devices, from accessing private network 194 by denying access to these devices beyond access network 192.

For example, when set-top box device 114 accesses IPTV system 100 via access network 192, client gateway 147 verifies subscriber information by communicating with subscriber and system store 145 via private network 194, APP switch 140, and APP switch 141. Further, client gateway 147 verifies billing information and status by communicating with OSS/BSS gateway 144 via private network 194 and APP switch 140. OSS/BSS gateway 144 transmits a query across APP switch 140, to APP switch 141, and APP switch 141 communicates the query across public network 196 to an OSS/BSS server 164 (described below). After the client gateway 147 confirms subscriber and/or billing information, client gateway 147 allows set-top box device 114 access to IPTV system 100 content and VOD server 136 content. If client gateway 147 cannot verify subscriber information for set-top box 114, such as when set-top box 114 is connected to a different twisted pair, or when set-top box 114 is stolen, client gateway 147 denies transmissions to and from set-top box device 114 beyond access network 192.

Domain controller 146 communicates with public network 196 via APP switch 141. Domain controller 146 includes a web portal that allows a subscriber to access IPTV system 100 using a personal computer 198. Domain controller 146 also communicates with a data network 172 that is connected to a wireless access point 174. Wireless access point 174 communicates with a subscriber's wireless device 176 to provide wireless access to IPTV system 100. A non-limiting example of a wireless device 176 includes a cellular telephone, a personal digital assistant, a mobile e-mail device, a portable digital video device, another wireless device, or any combination thereof. Wireless device 176 includes a display device 178 for displaying information from IPTV system 100. Display device 178 includes a text display, a picture display, a video display or any combination thereof.

Acquisition tier 106 includes an acquisition tier (AQT) switch 150, a live acquisition server 152, a broadcast service 154, and a video-on-demand importer server 156. AQT switch 150 manages communication with CF tier 104 and application tier 104 through private network 194, and with application tier 104 and OM tier 108 through public network 196. AQT switch 150 is coupled to live acquisition server 152, and video-on-demand importer server 156. Live acquisition server 152 acquires television content from broadcast service 154. Live acquisition server 152 sends the television content to AQT switch 150 for transmission to CF tier 102 via private network 194. The television content is further encoded at data server 132, and sent to client equipment 110 via access network 192. Set-top box 114 receives the television content from modem 112, decodes the television content, and transmits the information to display device 116 according to commands from remote control device 120.

Additionally, VOD importer server 156 receives content from one or more video-on-demand sources that are outside IPTV system 100, such as movie studios and programmers of non-live content. VOD importer server 156 transmits the video-on-demand content to AQT switch 150, and AQT switch 150 communicates the material to CFT switch 130 via private network 194. The video-on-demand content is stored on VOD server 136. When a subscriber issues a request for VOD content to set-top box 114 through remote control 118, the request is transmitted over access network 192 to VOD server 136 via CFT switch 130. Upon receiving such a request, VOD server 136 retrieves the requested VOD content and transmits the content to set-top box or 114 across access network 192 via CFT switch 130.

OM tier 108 includes an OM tier (OMT) switch 160, a TV2 server 162, the OSS/BSS server 164, and a simple network management protocol (SNMP) monitor server 166. OMT switch 160 manages the communication between OM tier 108 and public network 196. OMT switch 160 is coupled to TV2 server 162, OSS/BSS server 164, and SNMP monitor server 166 that monitors network devices. TV2 server 162 receives television content from live acquisition server 152, or video-on-demand content from VOD importer server 156 through public network 196. The television and video-on-demand content is sent by TV2 server 162 to OMT switch 160 and forwarded to a subscriber of IPTV system 100 who accesses public network 196 through personal computer 198.

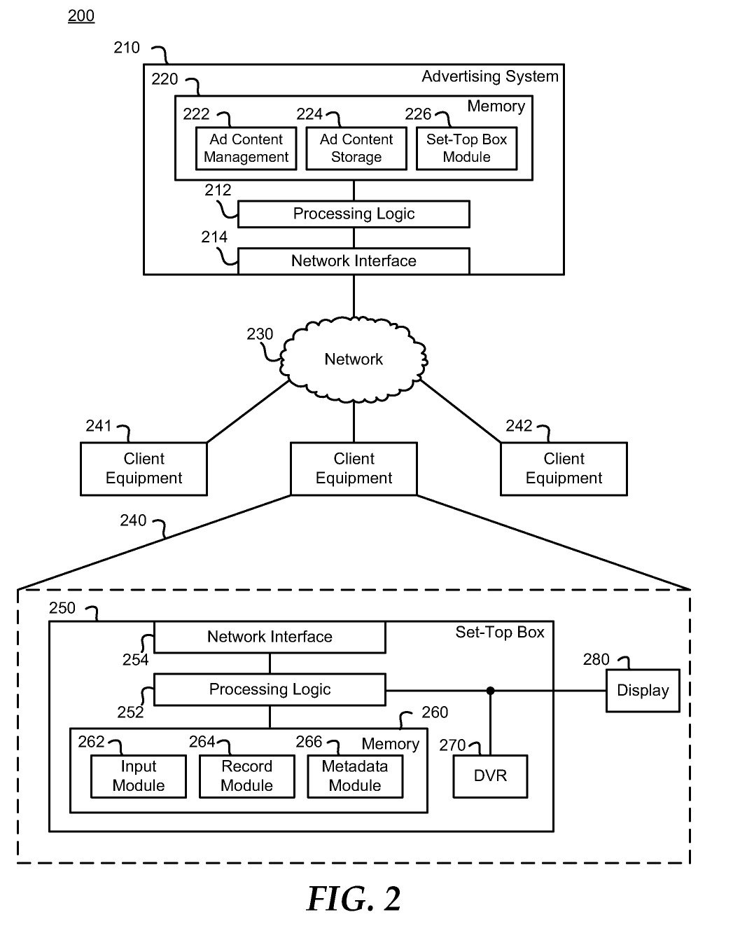

FIG. 2 illustrates an embodiment of an IPTV system 200 that includes an advertising system 210 that can selectively replace or renew expired advertisement content in a DVR recording of a content item. An advertisement content manager can determine if and when particular advertisement content is obsolete, select new advertisement content, and send the new advertisement content to the DVR to take the place of the original advertisement content in the content item. For example, the advertising system can tag particular advertisement content with metadata information that defines a run period specifying a length of time. Then, if the particular advertisement content has been on the DVR for longer than the run period, the particular advertisement content is deemed to be obsolete. In another example, the advertising system can tag particular advertisement content with metadata information that defines an expiration date. Then, if the current date is later than the expiration date, the advertisement content is deemed to be obsolete. The advertising system can then replace obsolete advertisement content by sending new advertisement content to a user's set-top box, and instructing the set-top box to erase the obsolete advertisement content on the DVR and to save the new advertisement content on the DVR. Then, when the user decides to view the content item, the user will see the new advertisement content, instead of the obsolete advertisement content. An example of a content item includes a television program, a movie, VOD content, music, a graphic presentation, another form of content, or a combination thereof. An example of advertisement content includes a product or service advertisement, a public service announcement, a television program announcement, another type of advertisement, or a combination thereof. Advertisement content is typically interspersed within a content item, and includes information chosen by the IPTV system operator to be delivered to the user.

IPTV system 200 is similar to IPTV system 100 and includes an advertising system 210 that communicates with client equipment 240, 241, and 242 via a network 230. Advertising system 210 includes processing logic 212, a network interface 214, and a memory 220. Network interface 214 is adapted to facilitate communication between advertising system 210 and network 230. Memory 220 is accessible to processing logic 212. Memory 220 includes an advertisement content management module 222, an advertisement content storage module 224, and a set-top box module 226. Modules 222, 224, and 226 include computer instructions that are readable and executable by processing logic 212 to implement various functions of advertising system 210. A non-limiting example of modules 222, 224, and 226 includes different aspects of one or more software applications, operating systems, other computer programs, or a combination thereof. In another embodiment (not illustrated), memory 220, and modules 222, 224, and 226 are implemented as hardware logic or a combination of hardware logic and computer instructions. Client equipment 240, 241, and 242 can include devices of different types, and can communicate with different types of networks including the Internet, television access networks, such as cable, satellite and IPTV access networks, cellular networks, Wi-Fi networks, other wireless networks, or a combination thereof.

Advertisement content management module 222 manages the placement, scheduling, and timing of advertisement content in IPTV system 200. As such, advertisement content management module 222 receives advertisement content from various sources and stores the advertisement content on advertisement content storage module 224. For example, advertisement content management module 222 can receive an advertisement for a sale at a local merchant, and can store the advertisement on advertisement content storage module 224 for later distribution to users. When a content item is sent to client equipment 240, 241, and 242, advertisement content management module 222 determines when advertising breaks are scheduled, and directs advertisement content storage module 224 to send particular advertisement content to client equipment 240, 241, and 242. The content item may be sent to client equipment 240, 241, and 242 pursuant to a scheduled broadcast of the content item, or may be sent at the request of a user of client equipment 240, 241, and 242.

Set-top box module 226 sends and receives data from set-top boxes in client equipment 240, 241, and 242. For example, set-top box module 226 can direct set-top boxes, described below, in client equipment 240, 241, and 242 to record and display content items, provide messaging services, and process IPTV data and VOD material. Set-top box module 226 also receives requests from the set-top boxes for specific content items to be sent to client equipment 240, 241, and 242 at the request of a user.

Client equipment 240 includes a set-top box 250 and a display device 280. Client equipment 240 communicates with IPTV system 200 via network 230. Set-top box 250 includes processing logic 252, a network interface 254, a memory 260, and a DVR 270. Memory 260 is accessible to processing logic 252. Network interface 254 is adapted to facilitate communication between client equipment 240 and network 230. Memory 260 includes an input module 262, a record module 264, and a metadata module 266. Modules 262, 264, and 266 can be implemented as computer instructions that are readable and executable by processing logic 252, as hardware logic, or as a combination thereof.

Input module 262 receives and processes inputs from a user or from set-top box module 226. For example, input module 262 can receive an input corresponding to a content item search function, such as an input requesting recurrent searching and specifying one or more content item search terms. In another example, input module 222 can receive an input specifying one or more changes in content item search terms, an input indicating a request to discontinue recurrent searching, an input indicating that content item search terms is to be deleted, or any combination thereof.

Further, input module 262 receives data from set-top box module 226 indicating that set-top box 250 is to record one or more content items on DVR 270. Thus, for example, record module 264 can record the content items on DVR 270 or can instruct an external DVR (not illustrated) to record the content items. In another example, record module 264 can send the content items to display device 280.

Metadata module 266 reads metadata information associated with a content item. The metadata information may be read from a content item that is provided to set-top box 250 from IPTV system 200, or may be read from a content item that is recorded on DVR 270. For example, metadata module 266 can read metadata information associated with a television program recorded on DVR 270. Metadata can include electronic programming guide (EPG) information, other information provided with a content item and that characterizes the content item, or a combination thereof. Metadata module 266 also sends and receives data to IPTV system 200. For examples, metadata module 266 can communicate the metadata information associated with a particular content item recorded on DVR 270 to advertisement content management module 222.

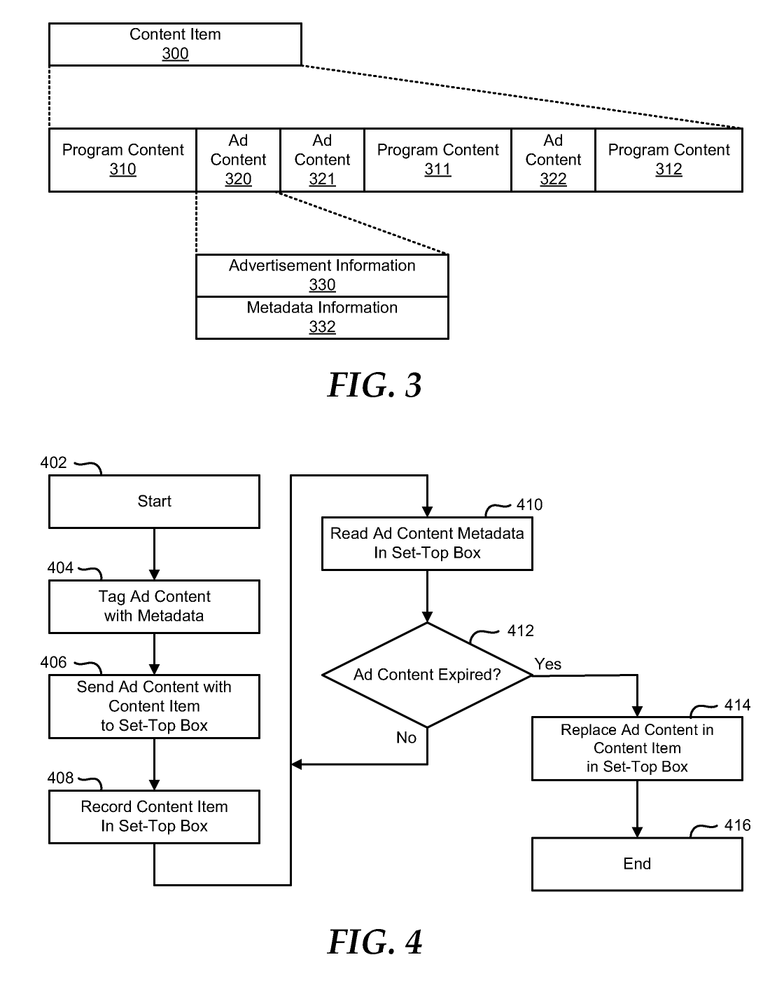

FIG. 3 illustrates a content item 300 that is recorded on DVR 270. Content item 300 is a program during which advertisements are shown. Thus, content item 300 includes one or more program content sections 310, 311, and 312, and one or more advertisement content sections 320, 321, and 322. Program content sections 310, 311, and 312 are typically viewed in order, and content sections 310, 311, and 312 are produced to be combined to make a complete program. For example, content sections 310, 311, and 312 can combine to make a movie, a television program, a VOD item, a music performance, another program, or a combination thereof. Advertisement content sections 320, 321, and 322 are typically interchangeable in the order in which they are presented, and can have no relationship to program content sections 310, 311, or 312, or to each other. For example advertisement content section 320 can include an advertisement for an automobile dealership, advertisement content section 321 can include an advertisement for a weekly special at a grocery store, and advertisement content section 320 can include a public service announcement for a weekly farmer's market.

Advertisement content section 320 includes advertisement information 330 and metadata information 332. Advertisement information 330 is information that is intended to be displayed to a viewer of advertisement content section 320. For example, advertisement information 330 can include audio and video information in the form of a television signal, a video file, another type of displayed information, or a combination thereof. Metadata information 332 is information that characterizes advertisement content section 320. For example, metadata information 332 can include a title for advertisement content section 320, a length of advertisement information 330, a sponsor name, a creation date, a file length, other information characterizing advertisement content section 320, or a combination thereof.

In a particular embodiment, advertisement content management module 222 creates a unique identifier for each advertisement content section 320, 321, and 322 and includes the unique identifier in metadata information 332. Advertisement content management module 222 keeps a list of the unique identifiers for all advertisement content provided on IPTV system 200, and an associated run period for each advertisement content. Then, in one aspect, advertisement content management module 222 periodically directs metadata module 266 to determine the unique identifiers for each advertisement content section 320, 321, and 322, and to return information including the unique identifiers to advertisement content management module 222. In another aspect, when a user desires to view content item 300, metadata module 266 determines the unique identifiers for each advertisement content section 320, 321, and 322, and returns information including the unique identifiers to advertisement content management module 222. In both aspects, advertisement content management module 222 then compares the received list of unique identifiers with their associated run periods, and determines if any of the run periods have expired. If any of the run periods have expired, advertisement content management module 222 directs advertisement content storage module 224 to send new advertisement content items to set-top box 250 to replace the expired advertisement content 320, 321, or 322 in content item 300. Record module 264 records the new advertisement content items and deletes the expired advertisement content 320, 321, or 322.

In another embodiment, advertisement content management module 222 includes a run period with metadata information 332. Then, in one aspect, set-top box 250 periodically directs metadata module 266 to determine the run period for each advertisement content section 320, 321, and 322. In another aspect, when a user desires to view content item 300, metadata module 266 determines the run periods for each advertisement content section 320, 321, and 322. In both aspects, set-top box 250 then determines if any of the run periods have expired. If any of the run periods have expired, input module 262 requests advertisement content storage module 224 to send new advertisement content items to set-top box 250 to replace the expired advertisement content 320, 321, or 322 in content item 300. Record module 264 records the new advertisement content items and deletes the expired advertisement content 320, 321, or 322.

FIG. 4 is a flowchart illustrating an embodiment of a method of substituting broadband delivered advertisements for expired advertisements. The method starts in block 402, and an advertisement content item is tagged with metadata in block 404. For example, advertisement content management module 222 can place a run period or an expiration date in metadata information 332 of advertisement content section 320. The advertisement content item is sent to a set-top box, along with a content item in block 406. Thus, when set-top box module 226 sends content item 300, advertisement content management module 222 can place advertisement content section 320 within content item 300, and set-top box module 226 can send content item 300 to set-top box 250. The content item is recorded in the set-top box in block 408. For example, set-top box 250 can direct record module 264 to record content item 300 on DVR 270.

The metadata in the advertisement content item is read in the set-top box in block 410. As such, metadata module 266 can read metadata information 332 from advertisement content section 320. In a particular embodiment, metadata module 266 can read metadata from advertisement content sections periodically. In another embodiment, metadata module 266 can read metadata from advertisement content sections when a particular content item is replayed on set-top box 250. A decision is made as to whether or not the advertisement content item is expired in decision block 412. For example, the advertisement content item may or may not have been recorded on the DVR for longer than a run period, or the current date may or may not be later than an expiration date. If the advertisement content item is not expired, the “NO” branch of decision block 412 is taken, and processing returns to block 410, where the advertisement content item is read again. If the advertisement content item is expired, the “YES” branch of decision block is taken, the advertisement content item is replaced in the content item in the set-top box in block 414, and processing ends in block 416. For example, advertisement content management module 222 can send a new advertisement content section to set-top box 250, and record module 264 can erase advertisement content section 320 and record the new advertisement content section to be replayed when content item 300 is replayed.

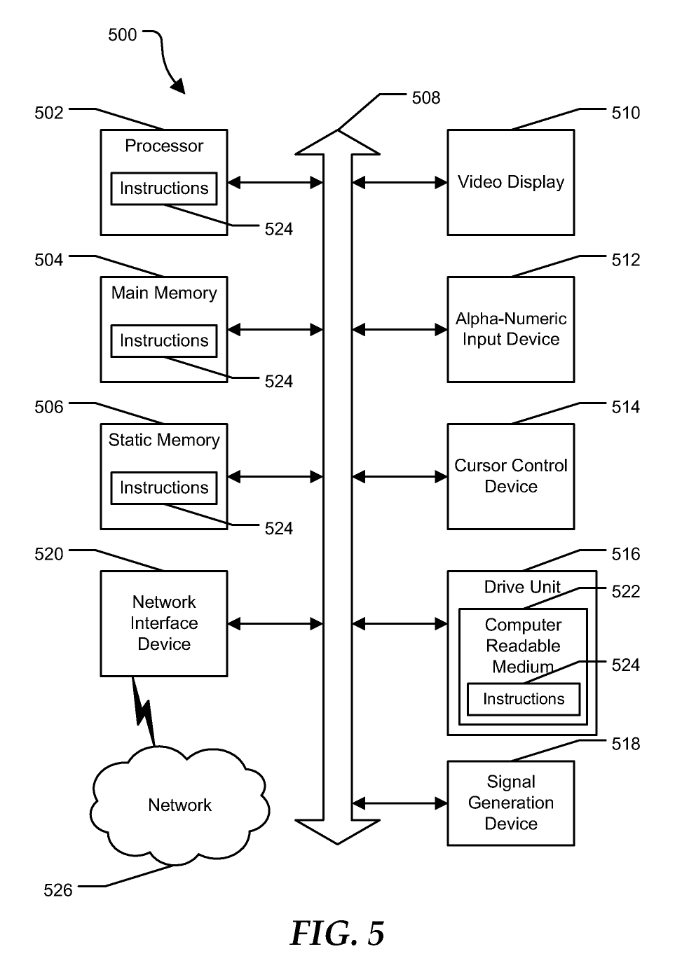

FIG. 5 shows an illustrative embodiment of a general computer system 500 in accordance with at least one embodiment of the present disclosure. Computer system 500 includes a set of instructions that can be executed to cause computer system 500 to perform any one or more of the methods or computer based functions disclosed herein. Computer system 500 can operate as a standalone device or can be connected via a network to other computer systems or peripheral devices.

In a networked deployment, computer system 500 operates in the capacity of a server or as a client computer in a server-client network environment, or as a peer computer system in a peer-to-peer (or distributed) network environment. Computer system 500 can also be implemented as or incorporated into various devices, such as a personal computer (PC), a tablet PC, a set-top box, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, computer system 500 is implemented using electronic devices that provide voice, video or data communication. Further, while computer system 500 is illustrated as a single system, the term “system” shall also be taken to include any collection of systems or sub-systems that individually or jointly execute a set, or multiple sets, of instructions to perform one or more computer functions.

Computer system 500 includes a processor 502 such as a central processing unit (CPU), a graphics processing unit (GPU), or both. Moreover, computer system 500 includes a main memory 504 and a static memory 506 that communicate with each other via a bus 508. Computer system 500 further includes a video display unit 510, such as a liquid crystal display (LCD), an organic light emitting diode (OLED), a flat panel display, a solid state display, or a cathode ray tube (CRT). Additionally, computer system 500 includes an input device 512, such as a keyboard, and a cursor control device 514, such as a mouse. Computer system 500 also includes a disk drive unit 516, a signal generation device 518, such as a speaker or remote control, and a network interface device 520.

In a particular embodiment, disk drive unit 516 includes a computer-readable medium 522 in which one or more sets of instructions 524 are embedded. Instructions 524 embody one or more of the methods or logic as described herein. In a particular embodiment, instructions 524 reside completely, or at least partially, within main memory 504, static memory 506, and/or within processor 502 during execution by computer system 500. Main memory 504 and processor 502 also include computer-readable media. Network interface device 520 provides connectivity to a network 526 such as a wide area network (WAN), a local area network (LAN), or other network. The present disclosure contemplates a computer-readable medium that includes instructions 524 or receives and executes instructions 524 responsive to a propagated signal, so that a device connected to network 526 can communicate voice, video or data over network 526. Further, instructions 524 can be transmitted or received by network 526 via network interface device 520.

In an alternative embodiment, dedicated hardware implementations such as application specific integrated circuits, programmable logic arrays and other hardware devices can be constructed to implement one or more of the methods described herein. Applications that include the apparatus and systems of various embodiments can broadly include a variety of electronic and computer systems. One or more embodiments described herein can implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein can be implemented by software code executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives can be considered a distribution medium that is equivalent to a tangible storage medium. Accordingly, the disclosure is considered to include any one or more of a computer-readable medium or a distribution medium and other equivalents and successor media, in which data or instructions can be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. An Internet Protocol television (IPTV) system comprising an advertising module adapted to:
read metadata information associated with a first advertising item included within a content item that is recorded on a set-top box;
determine that the first advertising item is expired;
send a second advertising item to the set-top box to be played on the set-top box in the place of the first advertising item when the content item is played on the set-top box; and
delete the first advertising item.

2. The IPTV system of claim 1, wherein the metadata information includes a run period.

3. The IPTV system of claim 2, wherein further, in determining that the first advertising item is expired, the advertising module is adapted to determine that the first advertising content has been recorded on the set-top box for a time duration that is longer than the run period.

4. The IPTV system of claim 1, wherein the metadata information includes an expiration date.

5. The IPTV system of claim 4, wherein further, in determining that the first advertising item is expired, the advertising module is adapted to determine that the current date is after the expiration date.

6. The IPTV system of claim 1, wherein the advertising module is further adapted to:
create the metadata information associated with the first advertising item; and
send the first advertising item and the content item to the set-top box.

7. The IPTV system of claim 1, wherein the advertising module determines that the first advertising item is expired when the content item is played on the set-top box.

8. A set-top box comprising:
a network interface adapted to receive a content item from an Internet Protocol television (IPTV) network, wherein the content item includes a first advertising item;
a recording device adapted to record the content item; and
a metadata module adapted to:
determine that the first advertising item is expired;
notify an advertising module in the IPTV network that the first advertising item is expired;
receive a second advertising item from the advertising module;
delete the first advertising item;
record the second advertising item; and
display the second advertising item in the place of the first advertising item when the content item is replayed from the recording device.

9. The set-top box of claim 8, wherein, in determining that the first advertising item is expired, the set-top box is further adapted to read metadata information associated with the first advertising item.

10. The set-top box of claim 9, wherein the metadata information includes run period information.

11. The set-top box of claim 10, wherein further, in determining that the first advertising item is expired, the set-top box is adapted to determine that the first advertising content has been recorded on the recording device for a time duration that is longer than the run period.

12. The set-top box of claim 8, wherein the metadata information includes an expiration date.

13. The set-top box of claim 12, wherein further, in determining that the first advertising item is expired, the set-top box is adapted to determine that the current date is after the expiration date.

14. The set-top box of claim 8, wherein the metadata module periodically determines that the first advertising item is expired.

15. The set-top box of claim 8, wherein the metadata module determines that the first advertising item is expired when the content item is played on the set-top box.

16. A method comprising:
determining at an advertising module in an Internet Protocol television (IPTV) system that a first advertising item is expired, wherein the first advertising item is included within a content item that is recorded on a set-top box;
in response to determining that the first advertising item is expired, sending a second advertising item to the set-top box;
deleting the first advertising item from the set-top box;
recording the second advertising item on the set-top box; and
playing the second advertising item in the place of the first advertising item when the content item is played on the set-top box.

17. The method of claim 16, wherein, in determining that the first advertising item is expired, the method further comprises reading metadata information associated with the first advertising item.

18. The method of claim 17, wherein:
the metadata information includes run period information; and
in determining that the first advertising item is expired, the method further comprises determining that the first advertising content has been recorded on the set-top box for a time duration that is longer than the run period.

19. The method of claim 17, wherein:
the metadata information includes an expiration date; and
in determining that the first advertising item is expired, the method further comprises determining that the current date is after the expiration date.

20. The method of claim 17, further comprising:
creating the metadata information associated with the first advertising item; and
sending the first advertising item and the content item to the set-top box.
